(19) United States
(12) Patent Application Publication
(10) Pub. No.: US 2009/0181720 A1
(43) Pub. Date: Jul. 16, 2009

(54) METHODS, SYSTEMS, AND COMPUTER READABLE MEDIA FOR A MOBILE HANDSET WITH DETACHABLE GAMING MODULE

(76) Inventor: Peter J. Marsico, Chapel Hill, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/353,951

(22) Filed: Jan. 14, 2009

Related U.S. Application Data
(60) Provisional application No. 61/021,142, filed on Jan. 15, 2008.

(51) Int. Cl. H04M 1/00; A63F 9/24

(52) U.S. Cl. 455/556.1; 463/41

(57) ABSTRACT

Methods, systems, and computer readable media for a mobile handset with a detachable gaming module are disclosed. According to one system, a mobile communications device having at least one mobile communications module performs a mobile communications function and executes at least one game. A gaming module, being detachably coupled to the mobile communications device, offloads data storage and processing associated with execution of the game from the mobile communications device to the gaming module.

### RELATED APPLICATIONS

This application claims the benefit of U.S. Provisional Patent Application Ser. No. 61/021,142 filed Jan. 15, 2008; the disclosure of which is incorporated herein by reference in its entirety.

### TECHNICAL FIELD

The subject matter described herein relates to gaming using a mobile communications device. More specifically, the subject matter relates to methods, systems, and computer readable media for offloading or supplementing processing and data storage resources from a mobile handset to a detachable gaming module.

### BACKGROUND

As mobile handsets have become increasingly popular gaming devices, the processing and data storage requirements for mobile handsets have also increased. Games played on mobile handsets have grown to include online, offline, single player, and multiplayer versions. For example, a user may use his or her mobile handset to communicate with a remotely located game server that is accessible via a communications network connection in order to play a game simultaneously with friends. This may include communicating via a public network, such as the Internet, or a private network, such as a corporate intranet. The game server may link multiple players together and/or provide game updates and user authentication. In other examples, the user may operate the handset in an offline (e.g., airplane) mode where the handset does not communicate with a communications network in order to play games. In an offline mode, game applications may be stored in memory local to the handset and executed by a processor within the handset.

One problem associated with playing games on conventional mobile handsets is that handsets typically do not have sufficient processing and data storage resources to provide high quality gaming experiences similar to that available on fixed (i.e., non-mobile) devices like desktop computers and dedicated game consoles. For example, in order to be small, light, and energy efficient, many mobile devices possess limited processing and data storage resources which are then optimized for voice calls or other non-gaming applications. This optimization may also include limiting the amount of traffic transmitted across a mobile communications network during game play. Thus, many games played on conventional mobile handsets are not graphics- or bandwidth-intensive because of these limitations. As a result, game players that play games on mobile handsets experience an inferior gaming experience as compared to gamer players using other fixed location devices.

Accordingly, in light of these difficulties, a need exists for improved methods, systems, and computer readable media for providing a high-quality gaming experience on a mobile handset.

### SUMMARY

Methods, systems, and computer readable media for offloading processing and data storage resources from a mobile handset to a detachable gaming module are disclosed. According to one system, a mobile communications device having at least one mobile communications module performs a mobile communications function and executes at least one game. A gaming module, being detachably coupled to the mobile communications device, offloads data storage and processing associated with execution of the game from the mobile communications device to the gaming module.

A method for providing a mobile device with a detachable gaming module is also disclosed. The method includes providing a mobile communications device having at least one mobile communications module performs a mobile communications function and executes at least one game. A gaming module, being detachably coupled to the mobile communications device, offloads data storage and processing associated with execution of the game from the mobile communications device to the gaming module.

The subject matter described herein for a mobile communications device with a detachable gaming module may be implemented using a computer readable medium to having stored thereon executable instructions that when executed by the processor of a computer control the processor to perform steps. Exemplary computer readable media suitable for implementing the subject matter described herein includes disk memory devices, programmable logic devices, and application specific integrated circuits. In one implementation, the computer readable medium may include a memory accessible by a processor. The memory may include instructions executable by the processor for implementing any of the methods for offloading or supplementing processing and data storage resources to a gaming module described herein. In addition, a computer readable medium that implements the subject matter described herein may be distributed across multiple physical devices and/or computing platforms.

### BRIEF DESCRIPTION OF THE DRAWINGS

The subject matter described herein will now be explained with reference to the accompanying drawings of which:

FIG. 1 is a diagram of a mobile handset and exemplary game modules suitable for coupling with the mobile handset according to an embodiment of the subject matter described herein;

FIG. 2 is a diagram of an exemplary internal architecture of a mobile device suitable for coupling with a game detachable game module according to an embodiment of the subject matter described herein;

FIG. 3 is a diagram of an exemplary internal architecture of a game module suitable for coupling with a mobile handset for supplementing or offloading processing and data storage resources according to an embodiment of the subject matter described herein;

FIG. 4 is a diagram of an exemplary internal architecture of a game module suitable for coupling with a mobile handset according to an embodiment of the subject matter described herein;

FIG. 5 is a diagram of an exemplary internal architecture of a game module suitable for coupling with a mobile handset according to an embodiment of the subject matter described herein;

FIG. 6 is a diagram of an exemplary internal architecture of a mobile device including a security authentication module suitable for coupling with a game module according to an embodiment of the subject matter described herein;

FIG. 7 is a diagram of an exemplary internal architecture of a game module including a security authentication module suitable for coupling with a mobile handset according to an embodiment of the subject matter described herein; and

FIG. 8 is a network diagram of an exemplary mobile communications network used for securely authenticating an exemplary mobile device coupled with a detachable game module according to an embodiment of the subject matter described herein.

### DETAILED DESCRIPTION

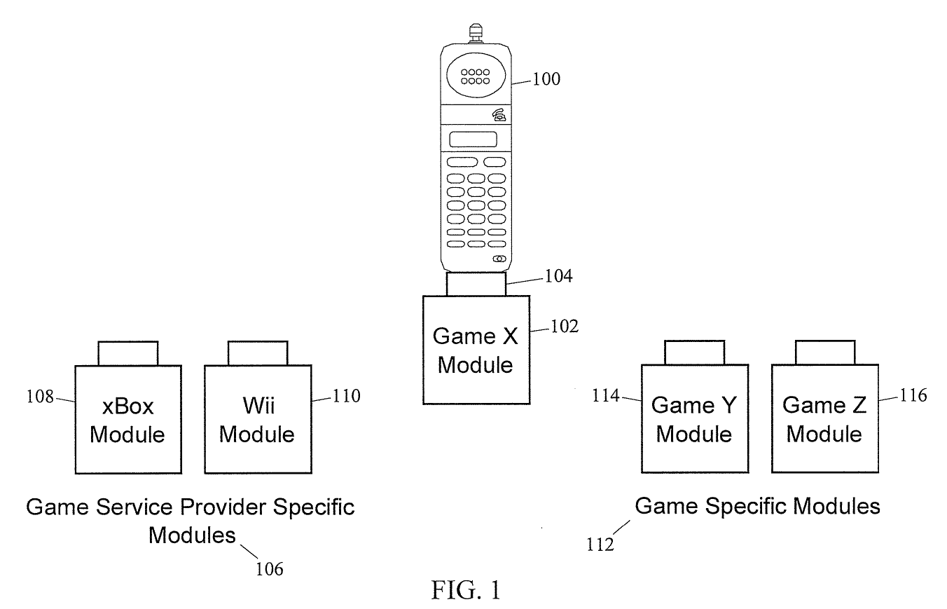

FIG. 1 is a diagram showing a mobile communications device and a plurality exemplary game modules suitable for being coupled with the mobile handset according to an embodiment of the subject matter described herein. Referring to FIG. 1, mobile device 100 may include any suitable mobile communications device capable of communicating with a mobile communications network and performing a mobile communications function (e.g., voice call). For example, mobile device 100 may include a GSM mobile phone, IS-41 handset, 3G voice over Internet protocol (VoIP) handset, a session initiation protocol (SIP) handset, Internet multimedia subsystem (IMS) handset, WiMax handset, and/or a portable computer.

Mobile device 100 may include a processor (not shown), memory (not shown), display (not shown), and keypad (not shown) for operating mobile device 100. Operation of mobile device 100 may include making or receiving voice calls, sending or receiving short message service (SMS) messages, interacting with non-gaming applications, and playing online and offline games. As described above, mobile device 100 may utilize local processing and data storage resources in order to perform mobile communications functions. However, for operations requiring large amounts of these resources, such as graphics- or bandwidth-intensive games, mobile device 100 may be limited in the amount of time the game may be played or the quality of the game experience. The quality of a gaming experience may include the frame rate of the game (higher is better), the number of visual effects (particles, high dynamic range lighting, anti-aliasing, etc.), the number of sound channels, and the input response time (faster is better). Each of these aspects may be affected by the amount of available processing, memory, and to a lesser degree, power available to the gaming application. Therefore, it may be desirable to provide additional processing and data storage resources in a separate, removable game module in order to supplement offload at least a portion of the functions previously performed by the local processor and memory of mobile device 100.

Mobile device 100 may also include an external communications interface for connecting to non-mobile local devices (e.g., a desktop computer). For example, interface 104 may be used for syncing mobile device 100 with information stored on a desktop computer or may be used to recharge mobile device 100. Interface 104 may include a universal serial bus (USB) or FireWire interface.

As shown in FIG. 1, game X module 102 may be detachably coupled to mobile communications device 100 for offloading data storage and processing resources associated with the execution of game X to gaming module 102.

It is appreciated that game modules may be game-specific or game service provider-specific. For example, game-specific modules 112 may include different modules for different games, regardless of the game's provider. Alternatively, game service provider-specific modules 106 may include multiple games associated with a common game service provider. For example, game service provider-specific modules 106 include an Xbox® game module 108 and a Wii® game module 110 for playing Xbox® and Wii® games, Xbox® being a game platform/service provided by Microsoft Corp. of Redmond, Wash., and Wii® being a game platform/service provided by Nintendo Corp. of Kyoto, Japan. Game-specific modules 122 may include game X module 102, game Y module 114, and game Z module 116 for playing games X, Y, and Z, respectively.

It is further appreciated that mobile device 100 may communicate with a variety of communications networks including, but not limited to, GSM, IS-41, code division multiple access (CDMA), time division multiple access (TDMA), next generation network (NGN), IMS, SIP, global packet radio system (GPRS), universal mobile telecommunications system (UMTS), WiFi, and WiMAX networks.

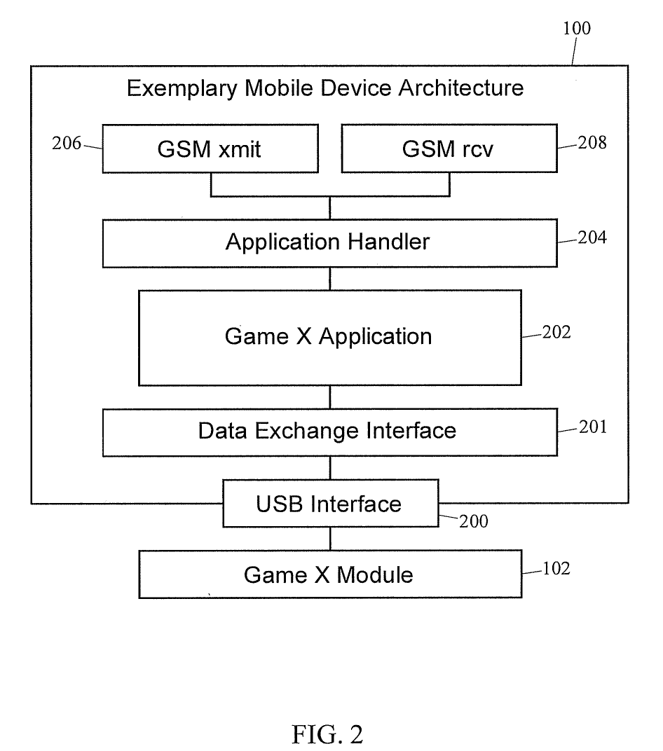

FIG. 2 is a diagram showing an internal architecture of an exemplary mobile device suitable for integrating with a game detachable game module according to an embodiment of the subject matter described herein. Referring to FIG. 2, exemplary mobile device 100 may be detachably coupled to game X module 102 via USB interface 200. A data exchange interface 201 may be internal to mobile device 100 and associated with external USB interface 104 for exchanging game data with game X module 102. For example, data exchange interface 201 may act as an intermediary between USB interface 200 and game X application 202 for facilitating communication between a game application (e.g., game X application 202) residing on mobile device 100 and one or more game-related functions residing on a game module (e.g., game X module 102).

Game X application 202 may execute a portion of the game code associated with playing game X that is not offloaded to Game X module 102. Exemplary functions performed by game X application 202 may include managing data input and output associated with the display and keypad, managing accelerometer data (if any), and load balancing with game X module 102.

Application handler 204 may direct data to and from gaming applications (e.g., game X application 202) or application instances that reside on mobile device 100. Application handler 204 may also be associated with GSM transmitter 206 and GSM receiver 208 for communicating with mobile communications networks. For example, GSM transmitter 206 and receiver 208 may include one or more antennas and associated hardware, software, and/or firmware for communicating wirelessly with a mobile communications network.

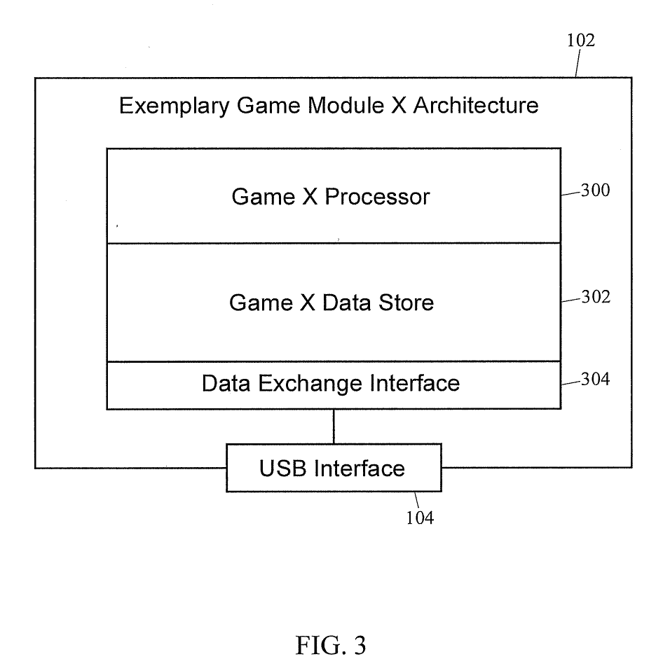

FIG. 3 is a diagram showing an internal architecture of an exemplary game module suitable for integrating with a mobile communications device according to an embodiment of the subject matter described herein. Referring to FIG. 3, game X module 102 may include a USB interface 104 for communicating with mobile device 100 upon being detachably coupled to its USB interface. Similar to mobile device 100, game X module 102 may include an internal data exchange interface 304 associated with USB interface 104 for acting as an intermediary between internal and external resources. Internal resources may include a game X processor 300 and a game X data store 302 that provide supplementary processing and data storage resources for mobile device 100.

Game processor 300 may include any suitable processor capable of executing instructions stored in game X data store or received from data exchange interface 304 associated with playing game X. It is appreciated that game X processor may include a general purpose central processing unit (CPU), field-programmable gate array (FPGA)-based processor, complex programmable logic device (CPLD)-based processor, or a graphics-specific graphics processing unit (GPU) without departing from the scope of the subject matter described herein.

Game X data store 302 may include any suitable memory for storing computer-executable instructions or related data files associated with playing game X. Game X data store 302 may be used to store large amounts of game-related data that could not be otherwise practically stored on mobile device 100. A game application residing on the mobile communications terminal may access game module-based data storage, such as game X data store 302, to retrieve data associated with a game. When a conventional mobile device 100 is playing an online game without a game module, mobile device 100 may be required to download a large amount of game-related data over a wireless network and permanently store the game data on local memory of mobile device 100 in order to play the game. However, in embodiments where mobile device 100 is coupled with game module 102, mobile device 100 may dynamically access and retrieve data from and store data to game module 102. In this way, large amounts of data associated with playing complex or graphics intensive game applications may be pre-loaded on game module 102 and dynamically accesses as game play progresses. By offloading at least some of the processing and data storage requirements of game X onto game X module 102, the amount of data that is pulled across the wireless network connection and stored on local memory of mobile device 100 is reduced.

Game X module 102 may also optionally include an auxiliary power source, such as a rechargeable battery, for increasing the power available to game X processor 300 and game X data store 302. In other cases, game X module 102 may rely on the power source provided by mobile device 100, which may be received via USB interface 104. It is also appreciated that game X module 102 may not be capable of playing a game without the aid of mobile device 100. Specifically, game X module 102 may lack a display, input device, and wireless transceiver necessary for playing a particular game, and therefore may rely on mobile device 100 for these aspects.

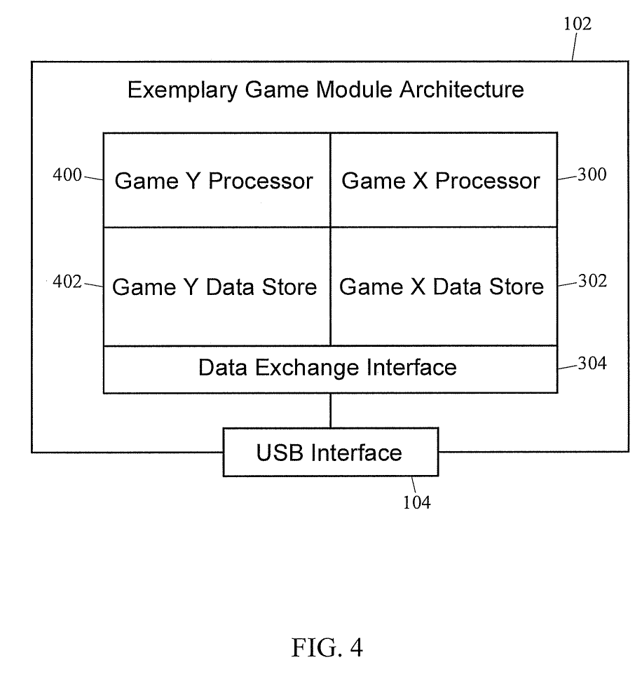

FIG. 4 is a diagram showing an internal architecture of an exemplary game module suitable for integrating with a mobile device according to an embodiment of the subject matter described herein. As opposed to the single processor/single data store embodiment shown in FIG. 3, the embodiment shown in FIG. 4 includes multiple game processors/game data stores, each being associated with a particular game. For example, game X processor 300 and game X data store 302 may be associated with executing game X, while game y processor 400 and game Y data store 402 may be associated with executing game Y.

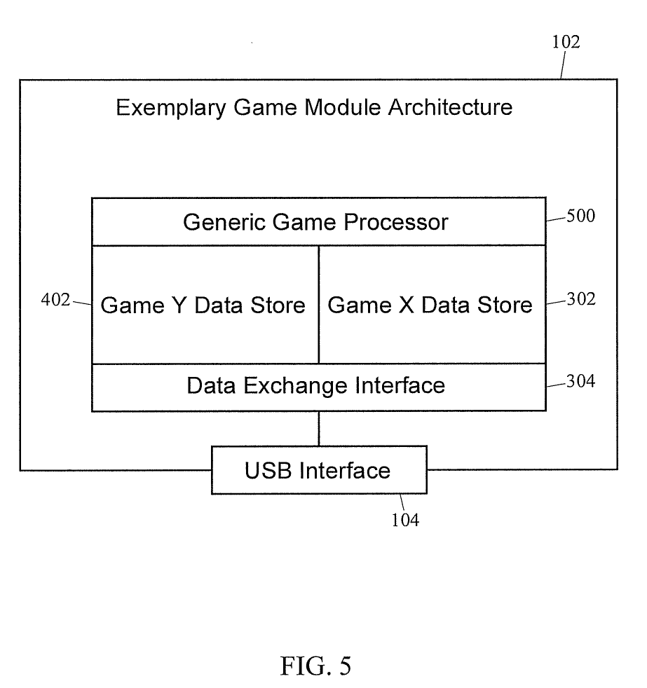

FIG. 5 is a diagram showing an internal architecture of an exemplary game module suitable for integrating with a mobile device according to an embodiment of the subject matter described herein. Referring to FIG. 5, in addition to USB interface 104, data exchange interface 304, and game processor 500, exemplary game module 102 may include multiple game data stores (i.e., game X data store 302; game Y data store 402) for playing multiple games. In contrast to the embodiment presented in FIG. 4, a single processor 500 may be shared among all game data stores 302 and 402. Such an embodiment may be advantageous in circumstances where multiple games have similar characteristics and therefore may be played equally well on a generic (e.g., un-optimized) processor. Additionally, the size, weight, and/or battery life of game module 102 may be improved by reducing and/or simplifying the circuitry associated with shared game processor 500.

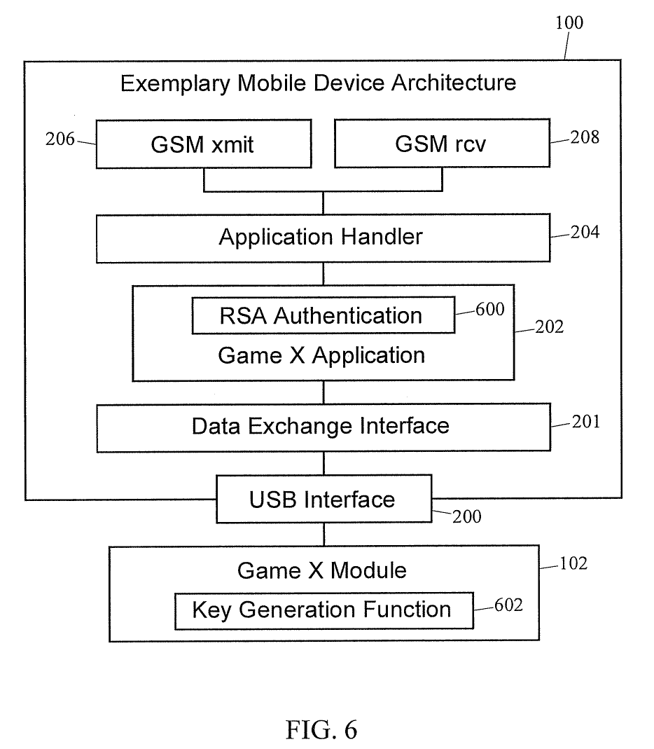

FIG. 6 is a diagram showing an internal architecture of an exemplary mobile device including a security authentication module suitable for integrating with a detachable game module according to an embodiment of the subject matter described herein. Referring to FIG. 6, exemplary mobile device 100 may be detachably coupled to game X module 102 via USB interface 200 for playing game X. Data exchange interface 201 may be internal to mobile device 100 and associated with external USB interface 200 for exchanging data with game X module 102. For example, data exchange interface 201 may act as an intermediary between USB interface 104 and game X application 202 for facilitating communication between a game application (e.g., game X application 202) on mobile device 100 and one or more game-related functions residing on a game module (e.g., game X module 102). Application handler 204 may direct data to and from one or more gaming applications (e.g., game X application 202) or application instances that reside on mobile device 100. Finally, application handler 204 may be associated with GSM transmitter 206 and GSM receiver 208 for communicating with mobile networks. GSM transmitter 206 and receiver 208 may include one or more antennas and associated hardware, software, and/or firmware for communicating wirelessly with a mobile communications network.

Notably, in the embodiment shown in FIG. 6, game X application 202 may include an authentication module for authenticating the game player. For example, RSA authentication module 600 may utilize well known RSA public key encryption techniques for securely exchanging information between mobile device 100 and a remote game server. In other embodiments, a one-time programmable (OTP) memory may be used to securely store game or user authentication-related data. As used herein, OTP memory refers to an integrated circuit (IC) memory area or type that can only be written once, such as programmable read-only memory (PROM) and/or field programmable read-only memory (FPROM). RSA authentication module 600 may be configured to access a key generation function 602 residing on game module 102. The key generated by key generation function 602 may be transmitted to a remote game server for authenticating the game player.

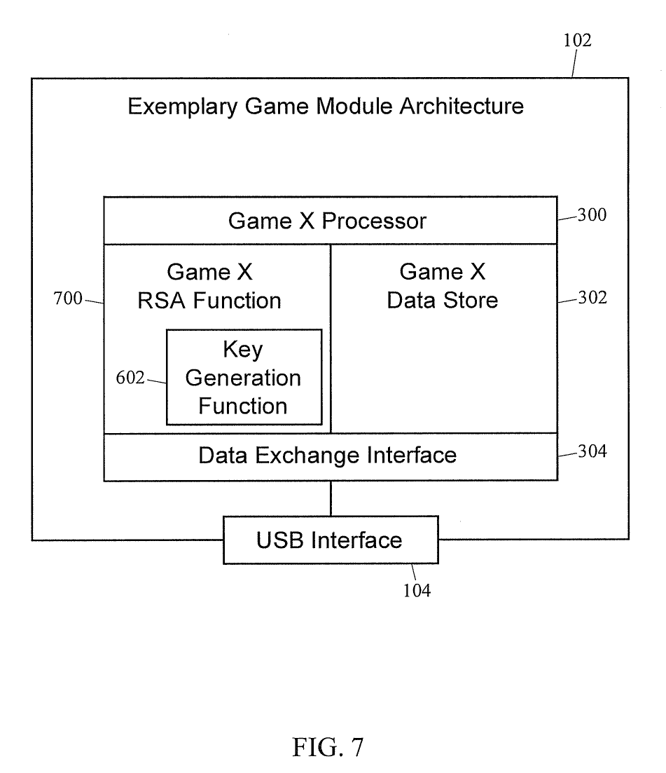

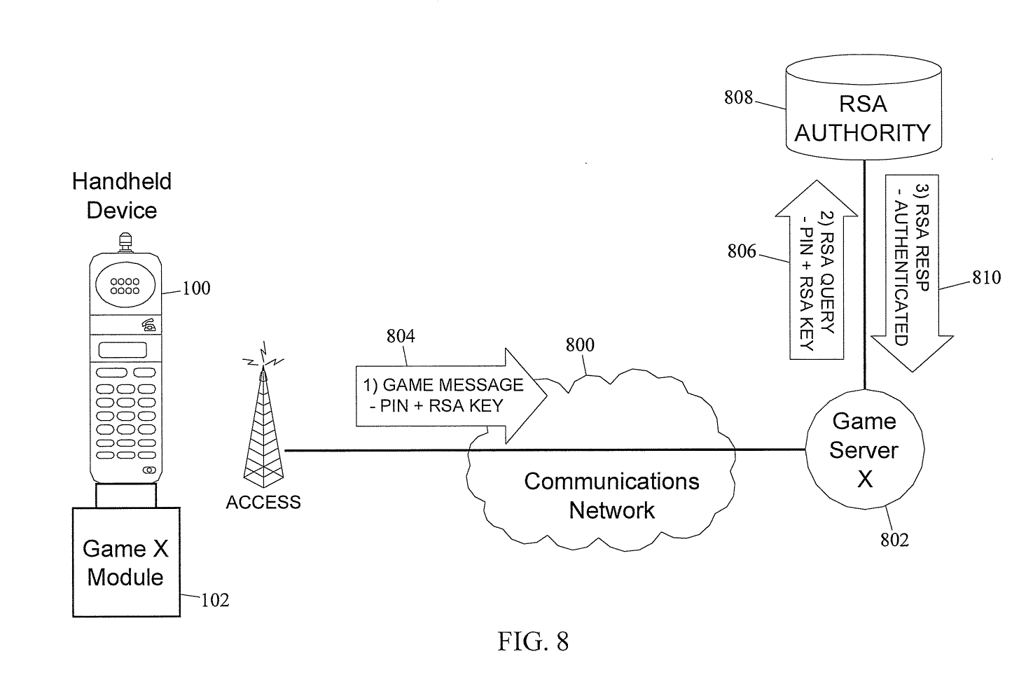

Alternatively, or in addition to the embodiment described above, RSA authentication module 600 may be used to encrypt/decrypt game-related data sent or received by mobile device 100 for providing a secure communications channel with a game server. Details of the encryption/decryption and user-authentication functions performed by module 600 will be described in greater detail below with respect to FIGS. 7 and 8.

FIG. 7 is a diagram showing an internal architecture of an exemplary game module including a security authentication module suitable for integrating with a mobile device according to an embodiment of the subject matter described herein. Referring to FIG. 7, game X module 102 may include a USB interface 104 for detachably coupling with mobile device 100 in order to exchange game-related data for playing game X. This information may be communicated internally via data exchange interface 304 to game X processor 300, game X data store 302, and game X RSA function 700. Game X RSA function 700 may be configured to authenticate the game player and/or securely communicate with a remote game server. For example, game X RSA function 700 may utilize well known RSA public key encryption/decryption techniques for securely exchanging information between mobile device 100 and a remote game server. Additionally, game X RSA function 700 may include a key generation function 602 for generating and managing PIN numbers and authentication keys associated with the gamer.

FIG. 8 is a network diagram of an exemplary mobile communications network for securely authenticating an exemplary mobile device coupled with a game module according to an embodiment of the subject matter described herein. Referring to FIG. 8, mobile device 100 is detachably coupled to game X module 102 for offloading at least a portion of the processing and data storage resources necessary for playing game X. Mobile device 100 may be connected to a mobile communications network for exchanging game-related data with game server X 802. For example, mobile device 100 may send game message 804 including a personal identification number (PIN) and RSA authentication/encryption key to game server X 802. Upon receiving game message 804, game server X 802 may forward game message 804 to RSA authority 808 for authentication. RSA authority 808 may include any suitable network function or node capable of authenticating game messages. For example, RSA authority 808 may store one or more private keys corresponding to the public keys generated by key generation function 602 and included in game message 804. RSA authority 808 may use well known RSA encryption and decryption techniques for processing private/public key pairs in order to authenticate mobile device 100. If mobile device 100 is authenticated, RSA authority 808 may generate and return RSA response message 810 to game server X 802.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A system for providing mobile communications and gaming functionality, the system comprising:
a mobile communications device having at least one mobile communications module for performing a mobile communications function and for executing at least one game; and
a gaming module being detachably coupled to the mobile communications device for offloading data storage and processing associated with execution of the game from the mobile communications device to the gaming module.

2. The system of claim 1 wherein the mobile communications device includes one of: a 2G global system for mobile communications (GSM) or IS-41 handset, a 3G voice over Internet protocol (VoIP) handset, a session initiation protocol (SIP) handset, an Internet multimedia subsystem (IMS) handset, a WiMax handset, and a portable computer.

3. The system of claim 1 wherein the mobile communications device includes a communications interface for exchanging at least one of information and power with the gaming module and detachably coupling the gaming module to the mobile communications device.

4. The system of claim 3 wherein the communications interface includes a universal serial bus (USB) interface.

5. The system of claim 1 wherein the mobile communications device further comprises a display and an input device.

6. The system of claim 1 wherein the mobile communications device includes one of a transmitter, a receiver, and a transceiver for communicating with a mobile communications network.

7. The system of claim 1 wherein the mobile communications device includes a secure authentication module for authenticating the mobile handset with a game service provider.

8. The system of claim 7 wherein the secure authentication module is configured to encrypt communications traffic between the mobile handset and the game service provider.

9. The system of claim 7 wherein the secure authentication module supports RSA encryption/decryption.

10. The system of claim 7 wherein the secure authentication module includes a one-time programmable (OTP) integrated circuit (IC).

11. The system of claim 1 wherein the gaming module is associated with a single game.

12. The system of claim 1 wherein the gaming module is associated with a game service provider.

13. The system of claim 12 wherein the gaming module is associated with multiple games.

14. The system of claim 1 wherein the gaming module includes one of: a central processing unit (CPU), a graphics processing unit (GPU), a field programmable gate array (FPGA)-based processor, and a complex programmable logic device (CPLD)-based processor for executing the at least one game.

15. The system of claim 1 wherein the gaming module includes a data storage module that is customized for storing data associated with the at least one game in a way such that provides faster access than for an uncustomized data storage module.

16. A method for providing mobile communications and gaming functionality, the method comprising:
providing a mobile communications device having at least one mobile communications module for performing a mobile communications function and for executing at least one game; and
providing a gaming module being detachably coupled to the mobile communications device for offloading data storage and processing associated with execution of the game from the mobile communications device to the gaming module.

17. The method of claim 16 wherein providing the mobile communications device includes providing one of: a 2G global system for mobile communications (GSM) or IS-41 handset, a 3G voice over Internet protocol (VoIP) handset, a session initiation protocol (SIP) handset, an Internet multimedia subsystem (IMS) handset, a WiMax handset, and a portable computer.

18. The method of claim 16 wherein providing the mobile communications device includes providing a communications interface for exchanging at least one of information and power with the gaming module and detachably coupling the gaming module to the mobile communications device.

19. The method of claim 18 wherein providing the communications interface includes providing a universal serial bus (USB) interface.

20. The method of claim 16 wherein providing the mobile communications device further comprises providing a display and an input device.

21. The method of claim 16 wherein providing the mobile communications device includes providing one of a transmitter, a receiver, and a transceiver for communicating with a mobile communications network.

22. The method of claim 16 wherein providing the mobile communications device includes providing a secure authentication module for authenticating the mobile handset with a game service provider.

23. The method of claim 22 wherein providing the secure authentication module includes providing a secure authentication module configured to encrypt communications traffic between the mobile handset and the game service provider.

24. The method of claim 22 wherein providing the secure authentication module includes providing a secure authentication module that supports RSA encryption/decryption.

25. The method of claim 22 wherein providing the secure authentication module includes providing secure authentication module including a one-time programmable (OTP) integrated circuit (IC).

26. The method of claim 16 wherein providing the gaming module includes providing a gaming module associated with a single game.

27. The method of claim 16 wherein providing the gaming module includes providing a gaming module associated with a game service provider.

28. The method of claim 27 wherein providing the gaming module includes providing a gaming module associated with multiple games.

29. The method of claim 16 wherein providing the gaming module includes providing one of a central processing unit (CPU), a graphics processing unit (GPU), a field programmable gate array (FPGA)-based processor, and a complex programmable logic device (CPLD)-based processor for executing the at least one game.

30. The method of claim 16 wherein providing the gaming module includes providing a data storage module that is customized for storing data associated with the at least one game in a way such that provides faster access than for an uncustomized data storage module.

31. A computer readable medium comprising computer executable instructions embodied in a tangible computer readable medium and when executed by a processor of a computer performs steps comprising:
providing a mobile communications device having at least one mobile communications module for performing a mobile communications function and for executing at least one game; and
providing a gaming module being detachably coupled to the mobile communications device for offloading data storage and processing associated with execution of the game from the mobile communications device to the gaming module.
